(19) United States
(12) Patent Application Publication
(10) Pub. No.: US 2008/0051526 A1
(43) Pub. Date: Feb. 28, 2008

(54) Coating composition

(75) Inventors: Alexander Yahkind, West Bloomfield, MI (US); Robert Liedtke, Lake Orion, MI (US); Christy Stine, Royal Oak, MI (US)

Correspondence Address: AKZO NOBEL INC., INTELLECTUAL PROPERTY DEPARTMENT, 120 WHITE PLAINS ROAD 3RD FLOOR, TARRTOWN, NY, 10591, US

(73) Assignee: AKZO NOBEL COATINGS INTERNATIONAL B.V., Arnhem (NL)

(21) Appl. No.: 11/250,818

(22) Filed: Oct. 14, 2005

Related U.S. Application Data
(60) Provisional application No. 60/618,888, filed on Oct. 14, 2004.

(51) Int. Cl. C08G 73/00; C08G 8/30

(52) U.S. Cl. 525/518; 528/367

(57) ABSTRACT

A coating composition for coating metal substrates includes polyurethane polyol (PUPO) and iron carbonyl to provide a coating with excellent weldability and corrosion resistance.

### RELATED APPLICATION

This application claims priority based on U.S. Provisional Application Ser. No. 60/618,888, filed Oct. 14, 2004.

### FIELD OF THE INVENTION

The present invention relates to a coating composition for coating metal substrates, which provides both excellent weldability and corrosion resistance. The coating composition includes polyurethane polyol (PUPO) and iron carbonyl. The PUPO does an excellent job of binding the iron carbonyl, as well as any additives (e.g., corrosion inhibitors), and the iron carbonyl provides for excellent weldability.

### BACKGROUND OF THE INVENTION

The automotive market has long utilized a weldable primer that is applied by a continuous coil coating process for coil sheet steel. After the primer is applied, the coil is recoiled and sent to automotive plants for forming into various body parts. The unique part of this process is that the primer is applied to the metal before it is formed.

In the 1970's and 1980's zinc rich coatings were applied as primers to automotive cold rolled steel. Generally, a chromate pre-treatment, for example Dacromet™, was coated on the steel followed by the application of the zinc rich coating. When the zinc rich coating used was Zincromet™, the pre-coated metal was called Zincrometal. During its peak time, Zincrometal was a product of choice for the passenger car body in the US and also used in Europe. This type of product/process was used extensively on cold rolled steel prior to the use of galvanized steel. The primer used on cold rolled steel was rich in zinc both for weldability and for corrosion resistance. Currently this type of product is being used in isolated markets over galvanized steel as zinc coated cold rolled steel and shows improved corrosion resistance over uncoated galvanized steel.

Galvanized steel is steel that is protected against corrosion with a layer of another metal. The protective layer can be applied by thermal (hot dip) or by electrolytic (electrolytic galvanizing) methods. The protective layer on steel substrates usually is a zinc comprising layer. With the development of galvanized steel in the mid 1980's, the automotive industry started to change from using cold rolled steel that has been coated with a zinc rich coating, to utilizing (electro-) galvanized steel.

Generally, (electro-) galvanized steel is manufactured in a coil. From the coil, (body) parts are formed, which are, optionally, subsequently electro-coated (E-coated).

As discussed above, the parts formed out of either traditional galvanized steel coil or out of (galvanized) steel coil are normally E-coated. This E-coat is a primer that prevents the steel against corrosion. A disadvantage of E-coating is that the coating may not reach a number of areas in the automotive body such as the hem flanges. Therefore, traditional galvanized steel coil is normally coated with a (pre)prime before the parts are formed. The pre-prime preferably is a conductive, anti-corrosive coating which insures the areas, which are not reached in an E-Coat process, have a primed surface to prevent corrosion. Generally, such pre-prime is applied, then the coil is recoiled, and next sent to automotive plants for forming into various body parts.

Besides the problem of reaching all areas, the use of E-coat is very expensive and requires submersion of the entire automotive body in a bath. The ability to pre-prime the galvanized metal is a way to eliminate the need for E-coat. Therefore, parts formed out of traditional pre-primed galvanized steel coil are sometimes used without subsequently E-coating them.

In the preparation of a pre-prime product, improved corrosion resistance can also be obtained by the use of PUPOs. PUPOs are prepared by the reaction of a multifunctional isocyanate with that of an α-β, or α-y-diol. Urethane linkages are then built into the backbone of the resin. General descriptions of the preparation of conventional PUPOs can be found in the patents of Gardon (U.S. Pat. No. 5,155,201A), Walker (U.S. Pat. No. 5,130,405A) and Yahkind (U.S. Pat. No. 6,624,277B2).

As noted above, it has been difficult to achieve both weldability and corrosion resistance in a coating composition. Usually, weldability requires a very thin film thickness, while corrosion resistance deteriorates with a thinner film. However, the present invention achieves both excellent weldability and corrosion resistance by combining PUPO and iron carbonyl in a coating composition. One feature of the invention is that it can be applied by conventional coil coating methods, e.g., reverse roll coat, etc.

### SUMMARY OF THE INVENTION

In summary, the coating composition of the invention includes PUPO and iron carbonyl, optionally with other resins and additives of the type used in coating compositions, although specific ones used herein might be different from those used before. As a result, a coating composition, process for coating the same, and a coated metal substrate with excellent weldability and corrosion resistance is realized.

### BRIEF DESCRIPTION OF THE DRAWINGS

FIG. 1 shows panels resulting from a cyclic test of 80 cycles;

FIG. 2 shows panels resulting from a cyclic test of 40 cycles;

FIG. 3 shows panels resulting from a cyclic test of 20 cycles;

FIG. 4 shows panels resulting from a cyclic test of 20 cycles;

FIG. 5 shows panels resulting from a spot welding test;

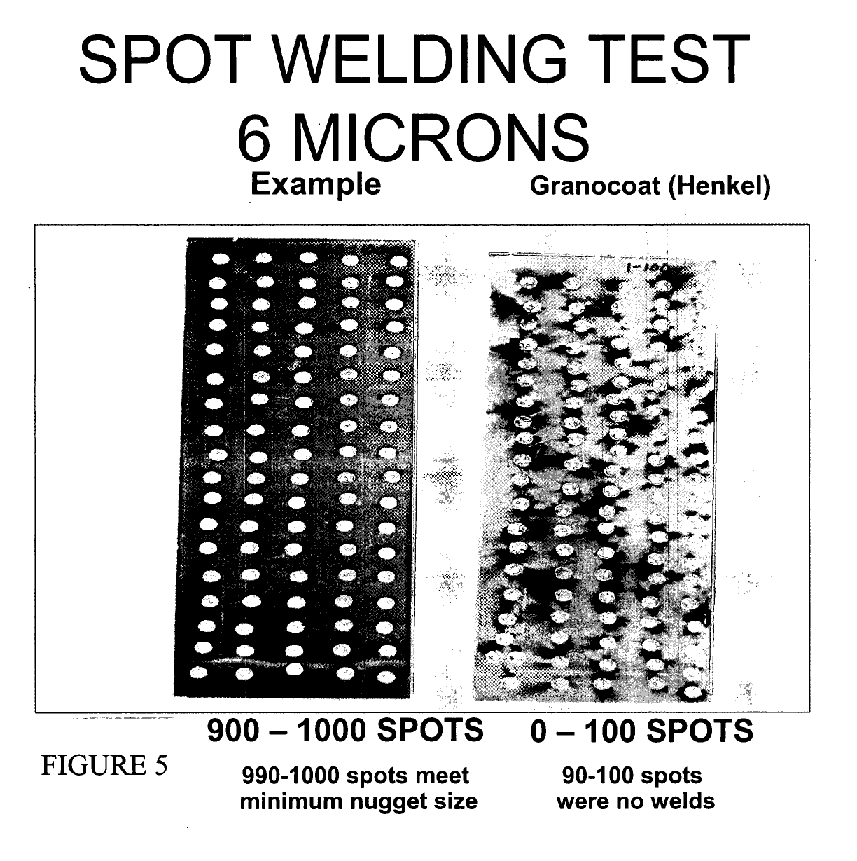

FIG. 6 shows panels resulting from a spot welding test;

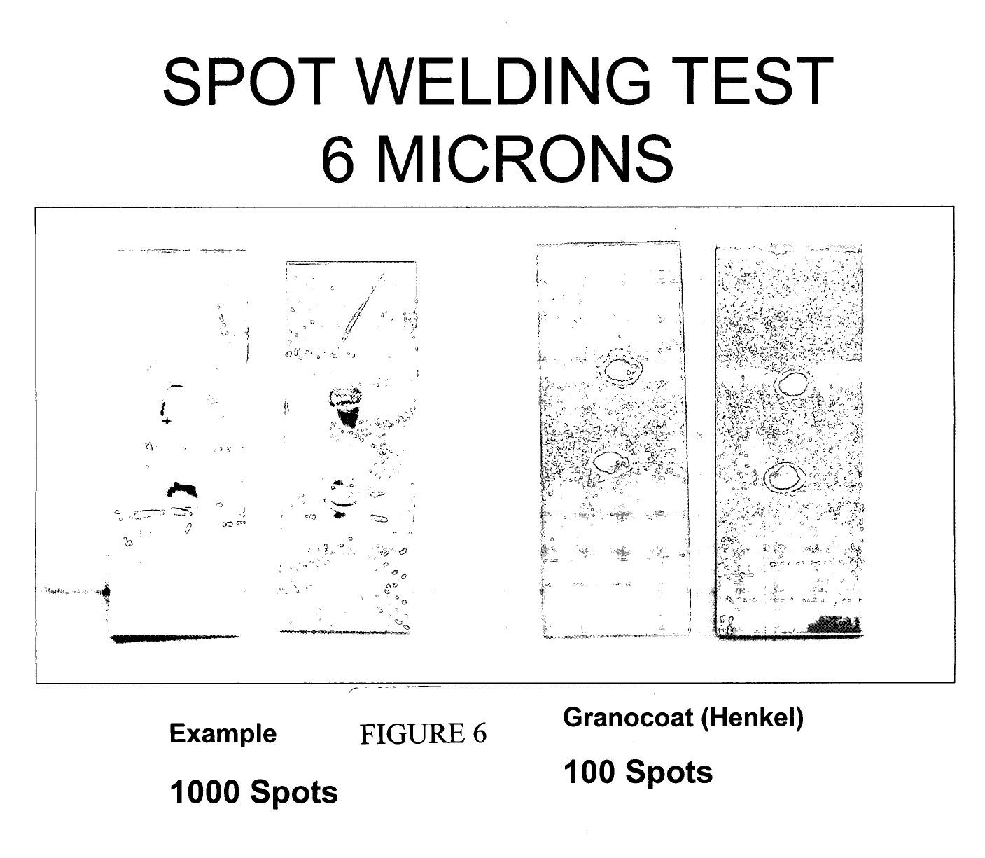

FIG. 7 is a table of results from a spot welding test;

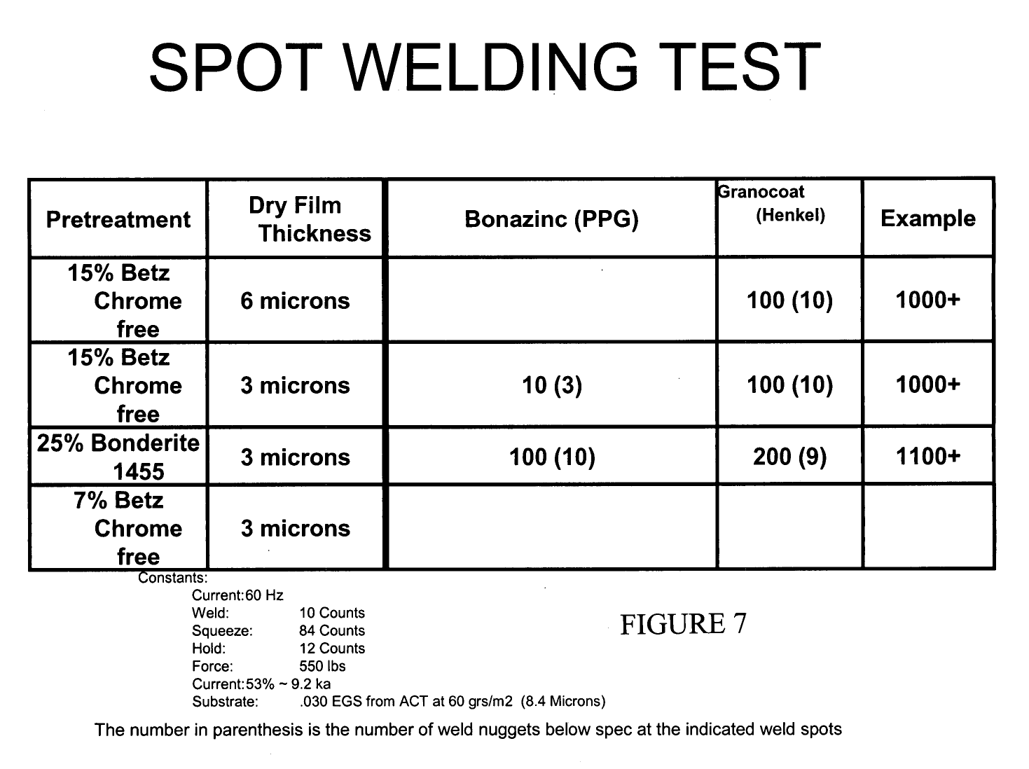

FIG. 8 is a graph of results testing the coefficient of friction;

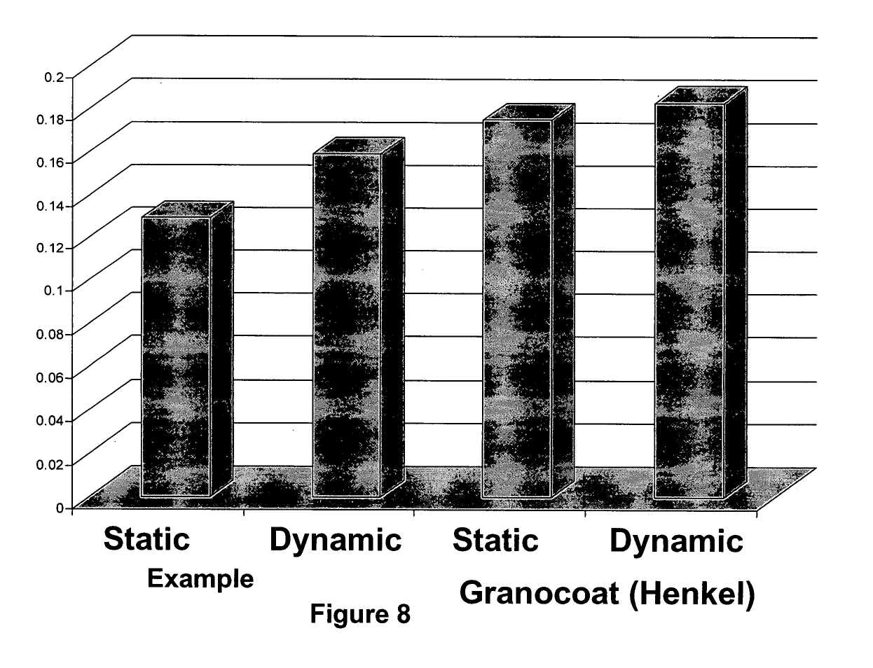

FIG. 9 shows photographs of the results of forming tests; and

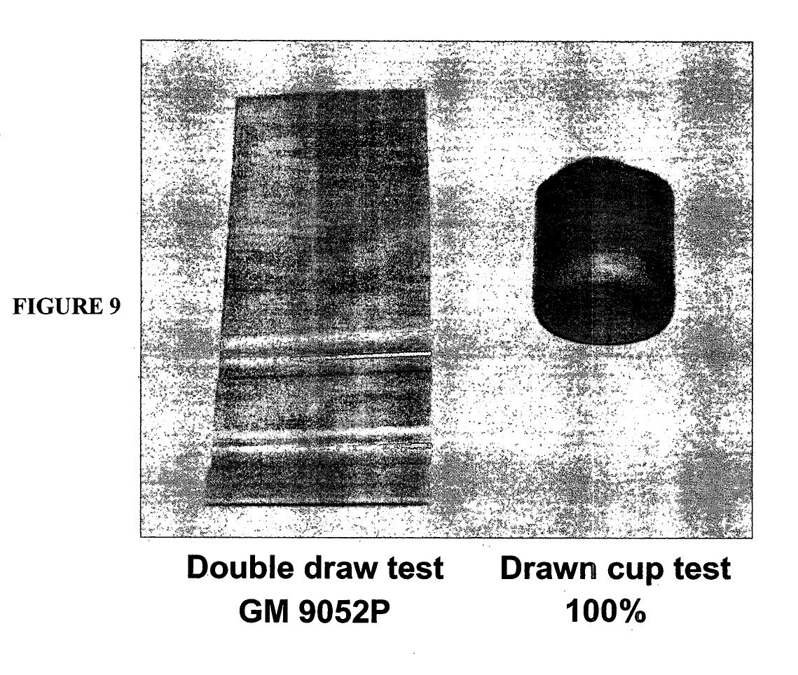

FIG. 10 is a table of results from adhesive bond testing.

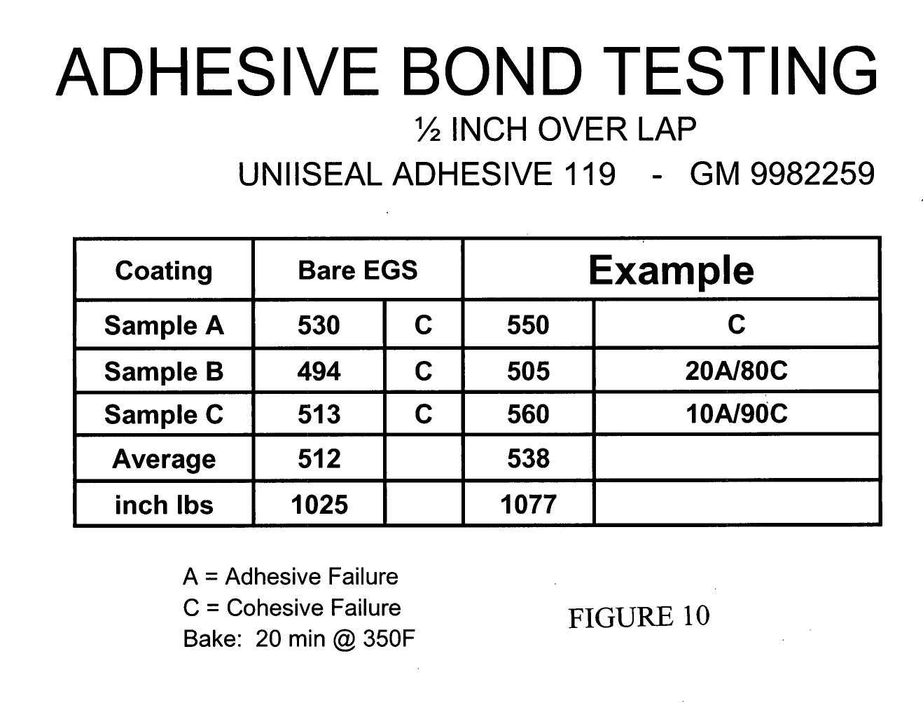

### DETAILED DESCRIPTION OF THE INVENTION

The coating composition of the present invention includes PUPO and iron carbonyl. Preferably, it also includes other resins and a variety of additives. Polyester resins, epoxy resins, phenoxy resin, etc., can be included in the coating composition.

Preferably, the PUPO in the composition has both flexibility and crosslinking ability. Means for achieving such a PUPO composition are apparent to those skilled in the art. For example, a single PUPO could have both flexibility and crosslinking ability, two or more PUPOs can be combined to achieve PUPOs that are flexible and ones that are self-crosslinking, a flexible PUPO can be combined with a more traditional blocked isocyanate, etc. The present inventors have tried to increase flexibility using a flexible PUPO with a long chain alcohol group on an isocyanate arm, e.g., Setal 10-9448 from Nuplex Resins. A separate PUPO was utilized by the present inventors to provide crosslinking ability by means of a partially blocked isocyanate (this PUPO is referred to as a modified PUPO in the formulations and is proprietary to Akzo Nobel). However, it is apparent to the skilled artisan that a single PUPO could be provided which has both flexibility and crosslinking ability.

Akzo Nobel's proprietary modified PUPO (used in the formulation examples) is modified by substituting some of the diols with that of a blocking agent that, under high temperature conditions (above 350 F.), will unblock to yield free isocyanate groups that can further react with other hydroxyl-containing compounds. Blocked isocyanates are described in the patent of Bayer Aktiengesellschaft (U.S. Pat. No. 3583943A)

The coating composition can also contain a high molecular weight phenoxy resin (e.g., wt. avg. MW 40,000-60,000). A representative example is Paphen PKHS 30 PMA, available from Phenoxy Assoc. This resin has been found to work well together with the PUPO and iron carbonyl of the inventive composition. A lower molecular weight epoxy resin can also be used.

Additives used in the inventive composition include those generally found in coating compositions. In particular, the inventive composition preferably includes one or more corrosion inhibitors (usually chromate-containing or chromate-free pigments (e.g., Calcium ion exchange silica, e.g., Shieldex AC5, available from Davison Grace)), one or more lubricants (organic (e.g., polytetrafluoroethylene (PTFE), etc.) or inorganic (e.g., graphite, boron nitride, molybdenum disulfide, etc.)), one or more suspension agents (e.g., clay (e.g., Tixogel MP 250, available from Sudchemie), etc.), in one or more solvent carriers.

Surprisingly, the unique combination of two lubricants, molybdenum disulfide and PTFE powder, provides formability of parts without putting undo stress on the fabrication dyes. For example, the inventors have tried Moly disulfide Tec, available from Amax Inc. and Micropower S1100, available from ISP, but these lubricants are available from other sources as well.

Representative examples of solvent carriers include, but are not limited to:

| | | |
|---|---|---|
| P.M. Acetate | Dow Chemical | Solvent |
| Di Basic Ester DBE | DuPont | Solvent |
| Diacetate Alcohol | Dow Chemical | Solvent |
| Cyclo Sol 100 | Exxon Chemical | Aromatic solvent |

The coating composition of the present invention is intended for use on metal substrates, but use on other substrates is not discouraged. Such metal substrates may be pre-treated and can include many zinc alloys, e.g., EG steel, hot dip galvanized, Galvanneal, etc.

The inventive coating composition can be applied by any known coil coating method. Further, it can be formed with a variety of techniques, including blanking dyes, hydroform, etc., without losing its weldability and corrosion-resistant properties.

In addition to excellent weldability and corrosion resistance, the inventive coating composition exhibits improved adhesive substrate bonding characteristics and a smoother finish. Another important advantage of the invention is that it obtains all of these benefits at very low dry film thicknesses (e.g., about 1 to about 10 microns dry film thickness (DFT), usually about 3 to about 5 microns DFT).

### EXAMPLES OF AMOUNTS/RANGES OF A FORMULATION OF THE INVENTIVE COMPOSITION

| | | Range 1 | Range 2 | Range 3 |
|---|---|---|---|---|
| | Weight % | wt. % | wt. % | wt. % |
| Raw Material | (about) | (about) | (about) | (about) |
| Phenoxy resin | 6.20 | 5-8 | 2-10 | 1-30 |
| P.M. Acetate solvent | 8.22 | 7-9 | 2-10 | 1-20 |
| Flexible PUPO | 11.57 | 10-13 | 2-15 | 1-50 |
| Akzo Nobel modified | 5.31 | 47 | 2-10 | 1-30 |
| PUPO | | | | |
| Lubricant | 0.36 | 0.1-0.5 | 0.1-1 | 0.1-5 |
| Lubricant | 0.51 | 0.1-0.6 | 0.1-1 | 0.1-5 |
| Iron carbonyl | 45.86 | 40-50 | 30-60 | 10-80 |
| Corrosion inhibitor | 10.38 | 8-12 | 5-15 | 1-30 |
| Di Basic Ester DBE | 5.46 | 4-6 | 1-10 | 1-30 |
| solvent | | | | |
| Diacetone Alcohol | 1.59 | 1-3 | 1-5 | 1-20 |
| solvent | | | | |
| Cyclo Sol 100 Aromatic | 1.59 | 1-3 | 1-5 | 1-20 |
| solvent | | | | |
| Suspension aid | 0.24 | 0.1-0.5 | 0.1-1 | 0.1-10 |
| Di Basic Ester DBE | 2.73 | 1-5 | 1-10 | 1-30 |
| sovent | | | | |
| TOTAL | 100.02 | | | |

The invention is further illustrated in the following Examples which, however, are not intended to limit the same.

Formulation Example 1

| Lbs. | Gal. | Component |
|---|---|---|
| 22.69 | 2.65 | Phenoxy Resin |
| 30.00 | 3.73 | PM Acetate Solvent |
| 42.36 | | Akzo Nobel modified PUPO Resin |
| 1.33 | 0.07 | PTFE powder |
| 1.87 | 0.05 | Molybdenum disulfide Powder |
| 167.84 | | Carbonyl Iron Powder (5micron) |
| 38.01 | 2.53 | Shieldex AC3 Anti-corrosive Pigment |
| 10.00 | 1.10 | DBE Di Basic Ester Solvent |
| 10.00 | 1.10 | DBE Di Basic Ester Solvent |
| 11.62 | 1.49 | Diacetone Alcohol Solvent |
| 11.62 | 1.60 | Aromatic 100 Blend Solvent |
| 1.73 | 0.12 | Bentone Powder |
| 19.44 | 2.36 | flexible PUPO Resin |
| 10.00 | 1.10 | DBE Di Basic Ester Solvent |

Formulation Example 2

| Lbs. | gallons | component |
|---|---|---|
| 94.84 | 11.08 | Phenoxy resin |
| 125.41 | 15.6 | P.M. Acetate solvent |
| 177.07 | 20.83 | Akzo Nobel modified |
| | | PUPO resin |
| 81.26 | 9.85 | Flexible PUPO |
| 5.55 | 0.31 | PTFE powder |
| 7.81 | 0.2 | Molybdenum disulfide |
| 701.64 | 11.03 | Micropower S1100 |
| 158.89 | 10.59 | Shieldex AC5 |
| 83.61 | 9.2 | Di Basic Ester DBE |
| | | solvent |
| 24.28 | 3.1 | Diacetate Alcohol |
| | | solvent |
| 24.28 | 3.34 | Aromatic solvent |
| 3.61 | 0.26 | clay |
| 41.8 | 4.6 | Di Basic Ester DBE |
| | | solvent |

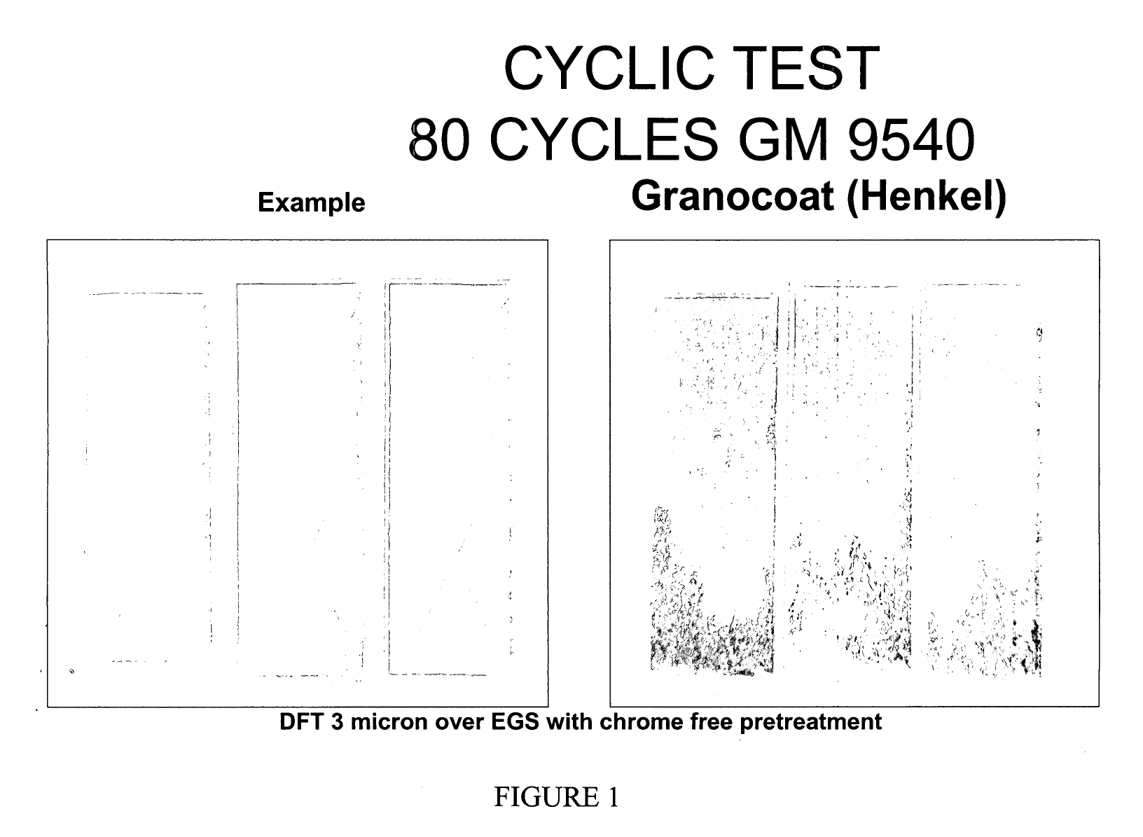

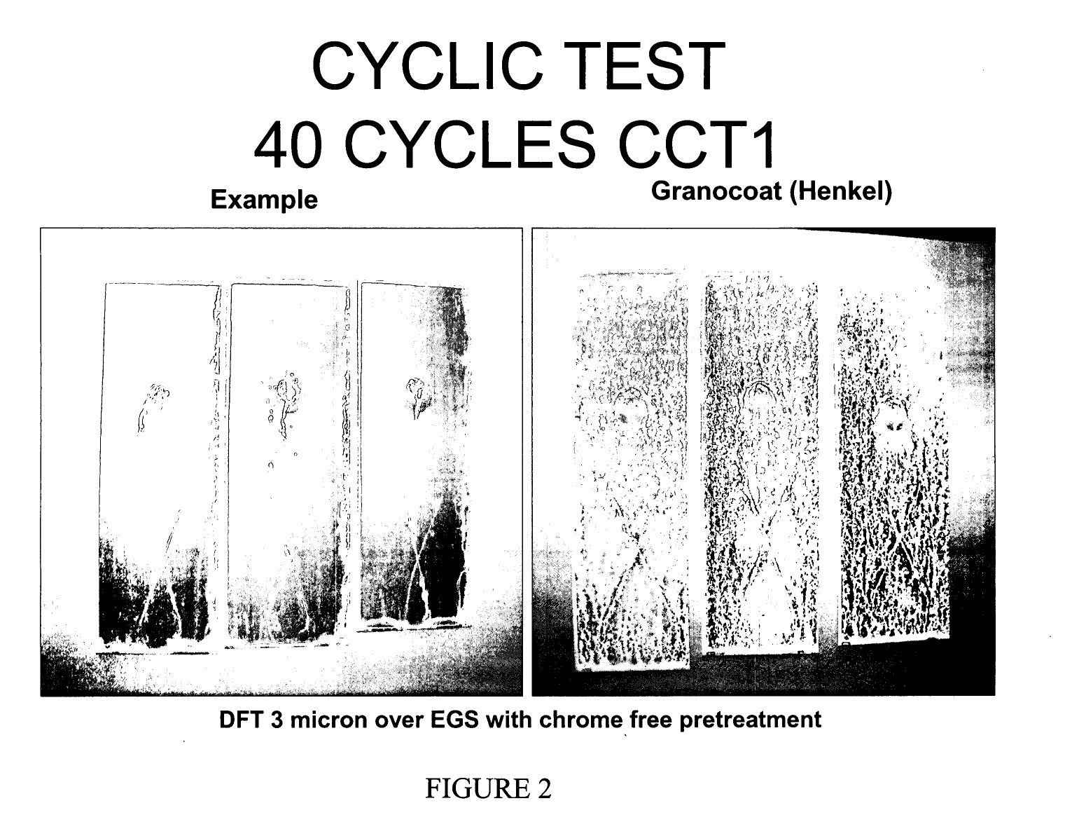

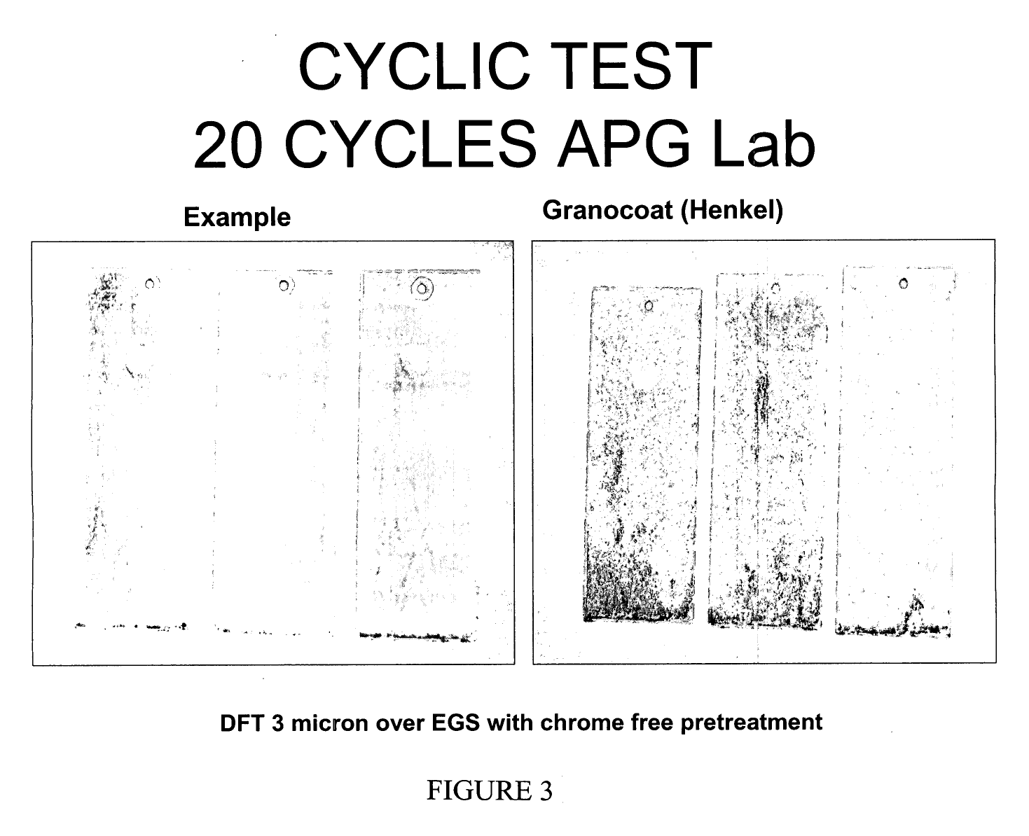

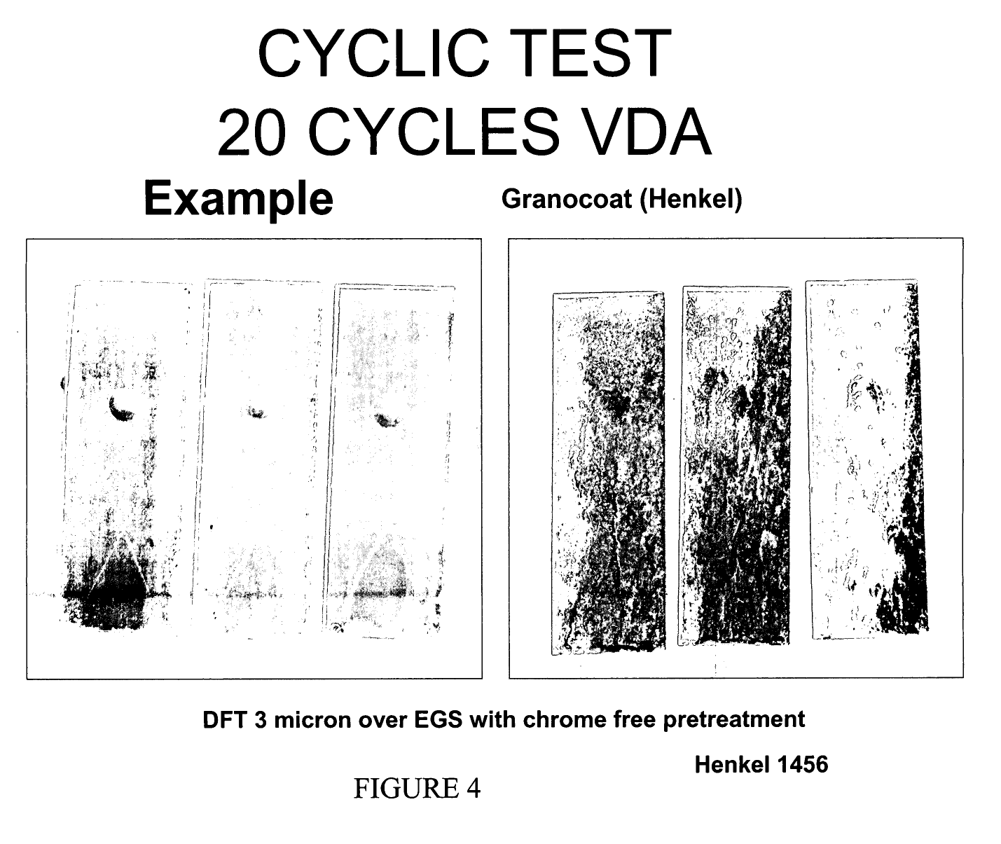

Formulation Example 2 was coated on panels which were subjected to cyclic tests of repeating cycles of humidity, salt, high temperature and dry conditions. The results of these tests are shown in FIGS. 1-4.

In one example, the coating composition is cured in the oven at about 430 F. peak metal temperature (PMT), wherein it cures in about 30 seconds at an oven temperature of about 750 F. However, other means of cure, temperature for curing, etc. are possible and apparent to the skilled artisan.

The invention is further illustrated by the following claims, which, however, do not limit the scope thereof.

1. A coating composition made from a mixture comprising polyurethane polyol and iron carbonyl.

2. The coating composition of claim 1, wherein the polyurethane polyol portion is flexible and crosslinking.

3. The coating composition of claim 1, wherein the polyurethane polyol portion is made up of one or more polyurethane polyols that provide both flexability and crosslinking ability.

4. The coating composition of claim 1, further comprising phenoxy resin having a wt. avg. Mw of about 40,000 to about 60,000, molybdenum disulfide and PTFE powder.

5. A coating composition made from a mixture comprising polyurethane polyol, iron carbonyl and calcium ion-exchange silica, wherein the polyurethane polyol portion is flexible and crosslinking.

6. A coating composition made from a mixture comprising about 2 to about 30 wt. % polyurethane polyol, about 2 to about 10 wt. % phenoxy resin having a wt. avg. Mw of about 40,000 to about 60,000, about 30 to about 60 wt. % iron carbonyl and about 5 to about 15 wt. % calcium ion-exchange silica, wherein the polyurethane polyol portion is flexible and crosslinking.

7. The coating composition of claim 6, further comprising molybdenum disulfide and PTFE powder.

8. The coating composition of claim 6, wherein the coating composition is coated on a metal substrate at a dry film thickness of about 3 to about 5 microns.

9. The coating composition of claim 6, wherein the coating is applied as a coil coating.
